(19) United States
(12) Patent Application Publication
(10) Pub. No.: US 2007/0288642 A1
(43) Pub. Date: Dec. 13, 2007

(54) Method for Initializing a Peer-to-Peer Data Network

(76) Inventors: Steffen Rusitschka, Munchen (DE); Alan Southall, Munchen (DE); Sebnem Oztunali, Munchen (DE)

Correspondence Address: STAAS & HALSEY LLP, SUITE 700, 1201 NEW YORK AVENUE, N.W., WASHINGTON, DC, 20005, US

(21) Appl. No.: 11/665,252

(22) PCT Filed: Oct. 6, 2005
(86) PCT No.: PCT/EP05/55043

§ 371 Date: Apr. 12, 2007

(30) Foreign Application Priority Data
Oct. 15, 2004 (DE) 10 2004 050 348.6

(51) Int. Cl. G06F 15/16

(52) U.S. Cl. 709/228

(57) ABSTRACT

A method initializes and/or updates a data network, particularly a peer-to-peer network, with a number of computers. A computer identity is assigned to each computer and each computer is able to establish a data link to another computer. One or more keywords are stored in each computer that characterize the data stored on the respective computer.

### CROSS REFERENCE TO RELATED APPLICATIONS

The application is based on and hereby claims priority to PCT Application No. PCT/EP/2005/055043 filed on Oct. 6, 2005 and German Application No. 10 2004 050 348.6 filed Oct. 15, 2004, the contents of which are hereby incorporated by reference.

### BACKGROUND

The invention relates to a method for initializing a data network and/or for locating and/or transmitting data in a data network, in particular a peer-to-peer network.

Peer-to-peer networks such as, for example, the “Gnutella” network are nowadays often used by users who would like to exchange information and data with one another. In this scenario the individual computers of the data network can be directly connected to one another in order to exchange corresponding data. In order to ascertain which data the other computers contain, in the Gnutella network queries from one computer are addressed to any computers in the data network in order to locate the desired data. This process is referred to as flooding, since the query is addressed without predefined criteria to all the computers, as a result of which a heavy load is placed on the network.

The idea of locating objects in a peer-to-peer network more quickly with the aid of keywords when conducting a search is known from the related art (see for example Michael Moore, Tatsuya Suda, “Adaptable Peer-to-Peer Discovery of Objects that Match Multiple Keywords”, SAINT Workshops 2004, pages 402 to 407). How a structured data network can be built with the aid of the use of keywords is not dealt with therein.

The publication US 2003/01 82 270 A1 discloses a method for searching for data in a peer-to-peer network wherein metadata for characterizing stored data is stored in the computers of the network and data is searched for in the network with the aid of the metadata.

### SUMMARY

One potential of the invention is to create a method for initializing a data network, a method for locating data in the data network and a method for transmitting data in the data network, wherein the data network is structured dynamically with the aid of the methods using keywords.

The inventors propose a method to initialize and/or update a data network, in particular a peer-to-peer network, wherein the data network comprises a plurality of computers and each computer is able to establish a data connection to another computer and wherein each computer is assigned a computer identity and one or more keywords which characterize data stored on the respective computer are stored in each computer. The term “keyword” is to be understood in a general sense in this context and comprises any character string including letters and/or numbers and/or other characters, although the keywords are preferably chosen such that they impart descriptive information to a user of a computer in the data network.

In a step a) of the method at least some of the computers of the data network forward messages to one another in order to ascertain for at least some of the keywords stored for the computers which computers contain the same or similar keywords. In a step b) a transmission layer which is characterized by the respective keyword and to which the computers with the same or similar keywords belong is generated for each keyword for which the same or similar keywords exist, with there being stored in each case in at least some of the computers information indicating to which transmission layers the respective computer belongs and which further computers belong to these transmission layers.

As a result of assigning the computers to transmission layers, logical connections are set up between the computers of the same transmission layers, since each computer of a transmission layer knows which further computers belong to its transmission layer. In this way, in a data network which is initialized by this method, search queries for keywords can be sent efficiently into the network, with only computers lying in a transmission layer which is characterized by at least one keyword of the search query being included during the forwarding of the search query. In contrast to known peer-to-peer networks, search queries can thus be distributed in a targeted manner in the network, and a flooding of the data network with search queries can be avoided.

In a preferred embodiment of the initialization method a message is processed and forwarded only by computers which have not yet received the message. In this way multiple processing of messages by the computers in the data network is prevented.

In a further embodiment step a) of the initialization method comprises the following substeps:
a.1) one or more computers of the data network generate messages, each of which contains the sender identity of the sending computer and at least some of the keywords stored in the sending computer;
a.2) the messages generated in step a.1) are forwarded by the computers in the data network, the computer which receives a forwarded message ascertaining those keywords from the received message which match or are similar to the keywords that it itself has stored;
a.3) each computer which has ascertained one or more matching or similar keywords in step a.2) sends a response including its computer identity and the keywords ascertained in step a.2) to the computer with the sender identity of the message received in step a.2).

As a result of a response being returned, the computer that originally generated a message is notified of which keywords it has in common with the computer from which it receives the response, and corresponding transmission layers can be generated in the computer which receives the response, with each transmission layer being assigned the computer from which the response originates.

In a further preferred embodiment of the initialization method, step b) of the method comprises the following substeps:
b.1) each computer which has ascertained one or more matching or similar keywords in step a.2) assigns, for each keyword ascertained, the computer with the sender identity of the previously received message to the transmission layer which is characterized by the ascertained keyword;
b.2) each computer which has received a response in step a.3) assigns, for each keyword contained in the response, the computer identity contained in the response to the transmission layer which is characterized by the keyword.

In this way a corresponding transmission layer is generated already in the case of computers which can receive a message and ascertain common keywords.

In a further embodiment of the method, a separate transmission layer is generated in at least some of the computers, to which layer the computers which are connected to the respective computer and which have no transmission layer in common with the respective computer belong. With this it is ensured that in subsequently executed search queries in which the searched-for keyword itself is not stored in the searching computer, the search query is nonetheless distributed in the data network via the separate transmission layer.

In a further preferred embodiment of the method, steps a) and b) of the initialization method are repeated with at least some of the computers of the data network at predefined time intervals and/or if the keywords stored in the computers are changed, the messages preferably being exchanged between computers that belong to the same transmission layers. In this way dynamic updating of the data network is made possible, with in particular transmission layers with newly added keywords being included during the updating and in addition computers that are no longer connected to the data network being deleted from the transmission layers present.

In a particularly preferred embodiment of the method, the computers of the data network communicate with one another via internet connections, the computer identities preferably being defined by the IP addresses of the computers. In particular the computers of the data network manage files and each file is assigned one or more keywords, the keywords of a file characterizing the contents of the file and being able to be searched for by users of the computers in the data network.

In a further embodiment of the method, at least some of the computers assign priorities to the transmission layers, with in particular a transmission layer receiving a higher priority the more frequently the keyword assigned to it has been searched for and/or found in the data network. In this way a succeeding search in the data network can be prioritized according to predetermined criteria, with certain keywords of the search being taken into consideration with preference before other keywords.

In addition to the initialization method just described, the inventors propose a method for locating data in a data network, said method comprising the following steps:
i) the data network is initialized and/or updated by the initialization method;
ii) a search query for one or more keywords is generated by at least one computer of the data network;
iii) the search query is forwarded to the computers of the data network, whereby prior to the forwarding of a search query a computer determines those of its transmission layers which are characterized by the keywords of the search query, and subsequently only computers of one or more of the thus determined transmission layers are taken into consideration during the forwarding;
iv) if a search query is received by a computer that belongs to one and/or more and/or all of the transmission layers which are characterized by keywords of the search query, the data on this computer linked with the keywords of the search query is identified as the data located by the method.

In this way it is ensured that an effective search is conducted only in transmission layers which are characterized by keywords of the search query.

In a preferred embodiment of the locating method, in the event that a computer cannot determine any transmission layers in step iii), all computers of the transmission layers to which said computer belongs are taken into consideration during the forwarding of the search query. This ensures that the search query is also forwarded when the corresponding computer has no transmission layer which is characterized by a keyword of the search query.

In a further embodiment of the locating method, during the forwarding of a search query a computer in step iii) prefers those transmission layers determined by it which the computer does not have in common with the computer from which it received the search query. Accordingly, a search query is efficiently forwarded to all transmission layers which are characterized by keywords of the search query.

In a further embodiment of the locating method, a search query is processed and forwarded by a computer only if the computer has not yet received the search query. This ensures that a multiple processing of the search query by a computer of the data network is avoided.

In a further embodiment of the method, in which the transmission layers are assigned different priorities, a computer forwards a search query only to the computers which belong to the determined transmission layer with the highest priority.

In addition to the method just described for locating data in a data network, the inventors propose a method for transmitting data in a data network wherein data is located in the data network by the locating method by way of a search query generated by a computer. Subsequently, the data is transmitted by the computer on which the located data resides at least in part to the computer which generated the search query.

In addition the inventors propose a data network, in particular a peer-to-peer network, wherein the computers of the data network are embodied in such a way that at least one of the methods described in the foregoing can be performed.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1 to 4: show schematic representations of a data network with reference to which the execution sequence of the proposed initialization method is explained;

FIGS. 5 and 6: show schematic representations of the transmission layers generated by the method with reference to which the data locating method is explained.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

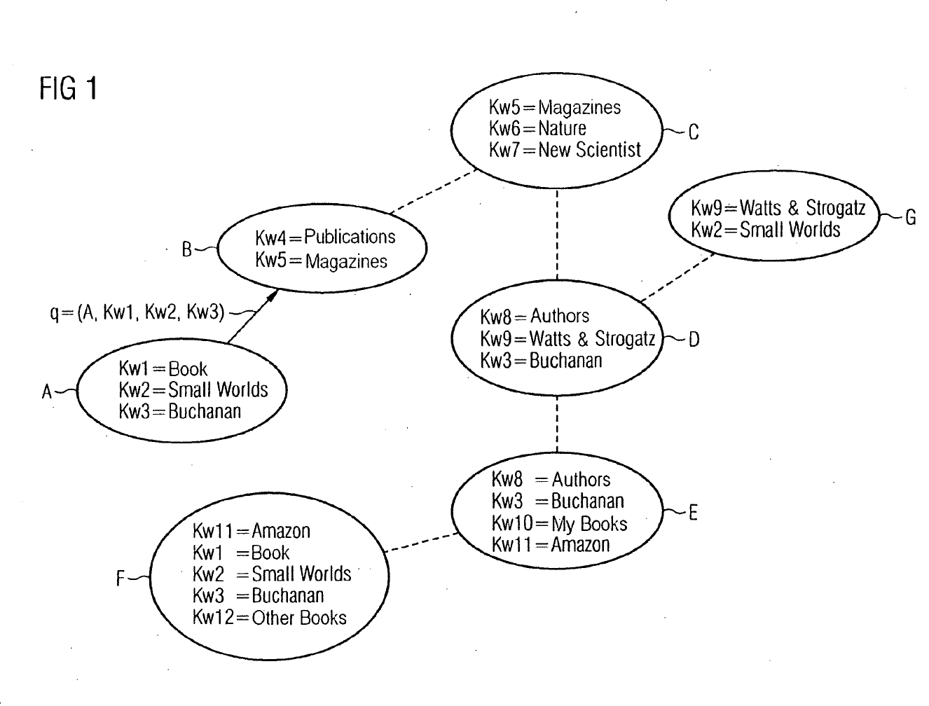

FIG. 1 is a schematic showing a peer-to-peer data network which comprises the peers A, B, C, D, E, F and G. By peer what is understood in the following is a computer of a data network which can act both as a server and as a client. In a peer-to-peer network of this kind each individual peer can connect directly to another peer from the network. On each of the peers resources are stored in the form of data, and the users of each peer would like to exchange data with users of other peers. In order to ensure an easier search for specific data content, the individual data elements, which are preferably present in the form of files, are linked with what are termed keywords which are intended to describe the contents of the individual files and are stored on the peers which contain corresponding files. In the embodiment described here a total of twelve keywords kw1 to kw12 are used containing the following description:
kw1=Book
kw2=Small Worlds
kw3=Buchanan
kw4=Publications
kw5=Magazines
kw6=Nature
kw7=New Scientist
kw8=Authors
kw9=Watts & Strogatz
kw10=My Books
kw11=Amazon
kw12=Other Books

By the keyword kw1 it is indicated for example that the corresponding peer on which the keyword is stored has files which include contents of books. By the keywords kw4 and kw5 it is communicated, for example, that literary content in the form of publications and magazines is stored on the corresponding peer. Analogously, the other keywords also convey corresponding information in respect of the content of the stored files.

With reference to FIGS. 1 to 4, it is described in the following how, starting from peer A, an initialization of the data network takes place by the method, with the remaining parts of the data network initially not being known to the peer A. The data connections between the computers B to G that exist during the initialization of the network are indicated by dashed lines.

For the purpose of initializing the data network, which is also referred to as a bootstrapping query, peer A initially connects to one or more arbitrary peers from the network. In FIG. 1 a connection is first established to peer B. The connection is established using known; for example, peer A transmits a so-called “ping” into the network and waits to see which computers answer it in response thereto. After a data connection has been established between peer A and peer B, peer A sends the query q=(A, kw1, kw2, kw3) to peer B. With this query, peer A transmits the computer identity assigned to it to peer B together with all the keywords kw1, kw2 and kw3 stored on it.

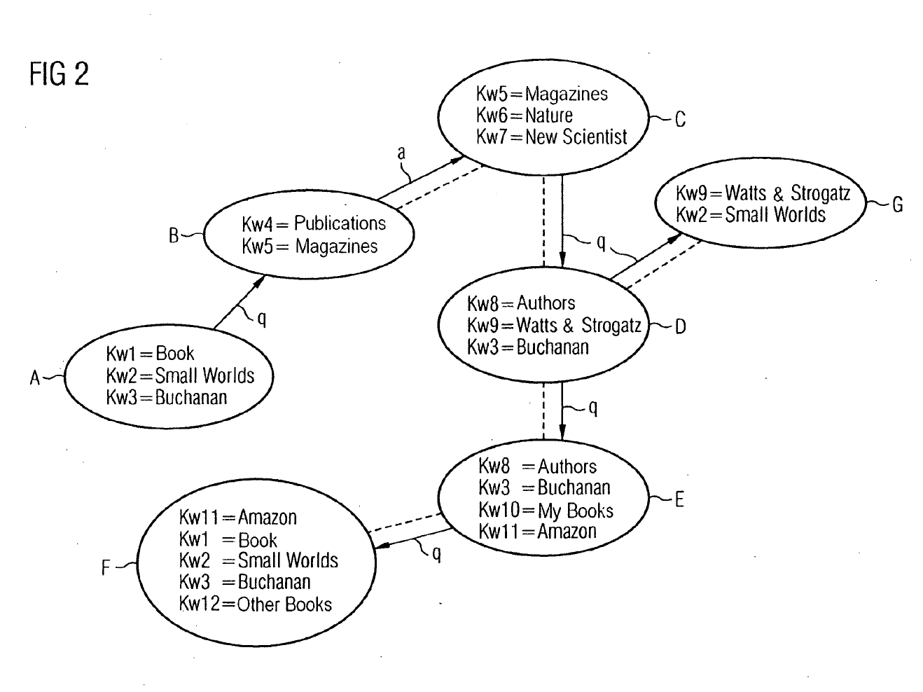

The query is then distributed across the entire data network, as indicated in FIG. 2. In particular the query initially reaches peer C via the data connections existing between peers B and F, from peer C finally reaches peer D, and from peer D subsequently reaches peer G and peer E. Finally, peer E additionally forwards the query to peer F. It should be noted here that a peer only takes into account and forwards a search query it receives when it receives it for the first time. This is why FIG. 2 depicts no further queries which are sent to the same peer for the second time.

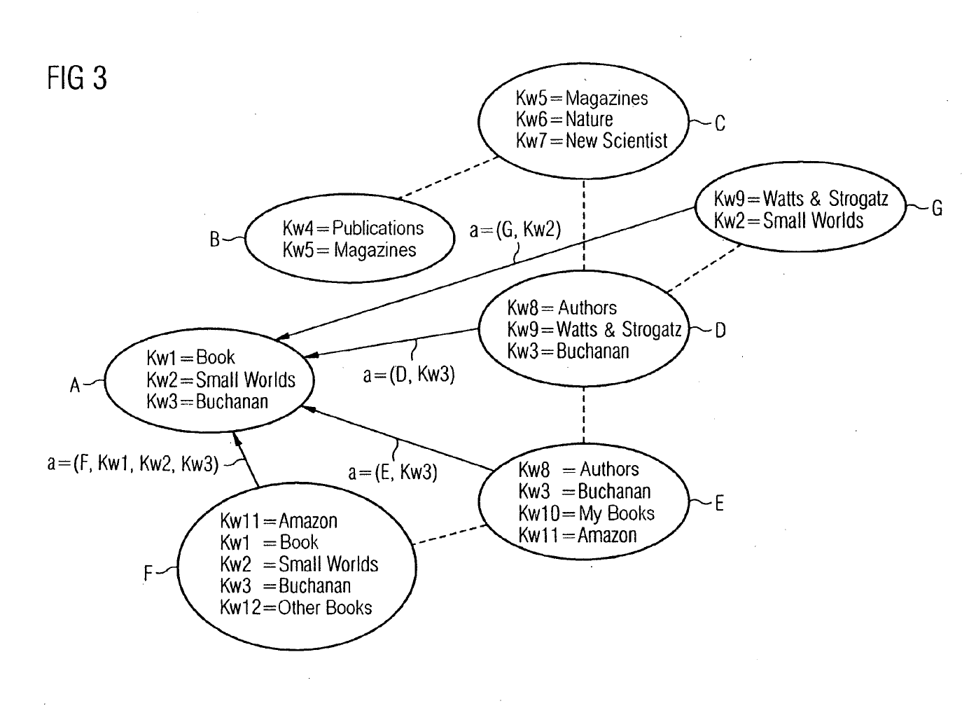

Each peer which receives a query first determines whether or, as the case may be, which keywords of the query match the keywords stored on it. As can be seen from FIG. 2, peer B and peer C have no keyword in common with peer A. These peers therefore only forward the queries, without performing further actions of their own. The first peer that has a keyword in common with peer A is peer D. Said peer has the keyword kw3, which is also stored on peer A. Before peer D accordingly forwards the query to peers G and E, it sends a response a=(D, kw3) back to peer A. This is shown in FIG. 3. The response contains the computer identity of peer D as well as the common keyword kw3. The response can be returned directly to peer A (as shown in FIG. 3), but can also be routed back to peer A on the same path by which the query reached peer D. Analogously, peer G ascertains that it has the keyword kw2 in common with peer A and sends a corresponding response a=(G, kw2) to peer A. In the same way peer E, which has the keyword kw3 in common with peer A, sends the response a=(E, kw3) to peer A. Peer F even contains all three keywords kw1, kw2, kw3 stored on peer A. For this reason it also transmits as its response to peer A all three keywords, i.e. a=(F, kw1, kw2, kw3), in addition to its own computer identity.

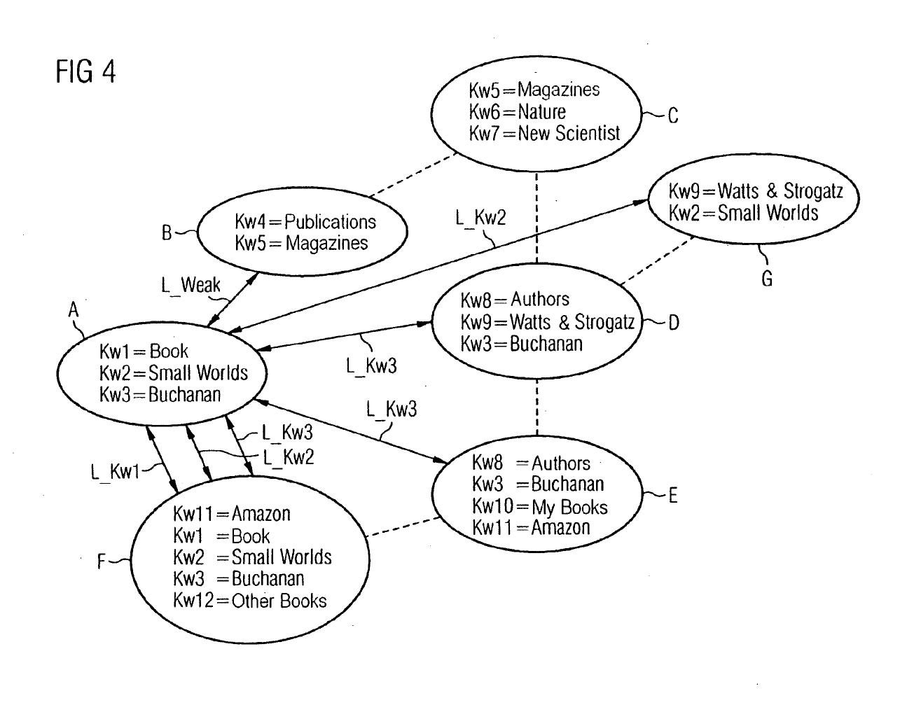

By the responses transmitted, peer A knows which peers have the same keywords as it. Peer A then generates transmission layers, each of which includes peers having the same keyword, with the result that logical connections are created between peer A and the peers with the same keywords, as indicated by double arrows in FIG. 4. In this scenario there exist the transmission layers L_kw1, L_kw2, L_kw3 for each keyword kw1, kw2 and kw3. In particular the transmission layer L_kw2 exists between peer A and peer G and the transmission layer L_kw3 exists between peer A and peer D as well as between peer A and peer E. The transmission layers L_kw1, L_kw2 and L_kw3 exist between peer A and peer F on account of all three common keywords. Information is therefore stored in peer A indicating to which transmission layers peer A itself belongs and to which further peers said transmission layers are assigned. Stored in particular in peer A is the information that layer L_kw1 is assigned peer F, layer L_kw2 is assigned peers F and G, and layer L_kw3 is assigned peers D, E and F. Analogously to peer A, the information relating to the transmission layers is also stored in peers B to G. This information is generated for example when the corresponding peer has received a query and was able to ascertain a common keyword corresponding to the query. The peer can then generate the transmission layer for the common keyword locally for itself and assign the sending computer to this transmission layer on the basis of the sender identity from the received query.
In addition to connections via the transmission layers L_kw1 to L_kw3, peer A also has what is termed a “weak” connection via a transmission layer L_weak to peer B, as can be seen from FIG. 4. Although peer A and peer B have no keywords in common, peer B was the first peer to which peer A established a connection. This connection is maintained so that at a later point in time peer A can also address search queries to peers with which it has no keyword in common. This is explained in more detail below. In general, for each peer in the data network, approximately 20 to 30% of all connections are weak connections between peers without keywords in common.

Analogously to peer A, corresponding queries q can also be sent into the data network by the further peers B to G. A this the individual transmission layers are supplemented by further associated peers. For example, this also produces a transmission layer between peers D and E as well as peers F and E, since they have the keyword kw3 in common.

To ensure that the peers detect changes in the network, peer failures, for example, or updates of the keywords, what is referred to as a “stabilize query” is performed at regular intervals, which query is essentially another execution of the bootstrapping method described in the foregoing, though with the query q preferably being sent by a peer along the layers already known to it. In this way peers newly added to the overall network can be assigned to already known transmission layers or further new transmission layers can be set up in the network. Equally, peers which are no longer present in the overall network can be removed from the corresponding transmission layers.

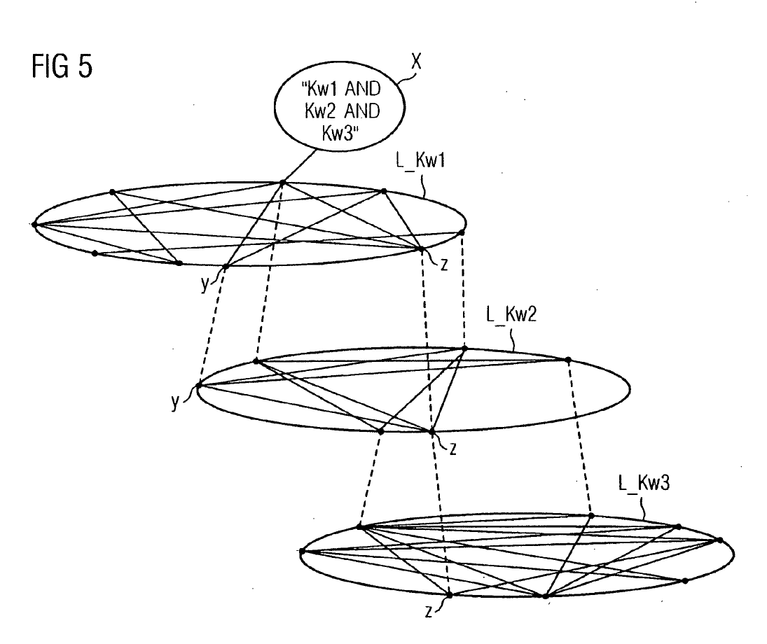

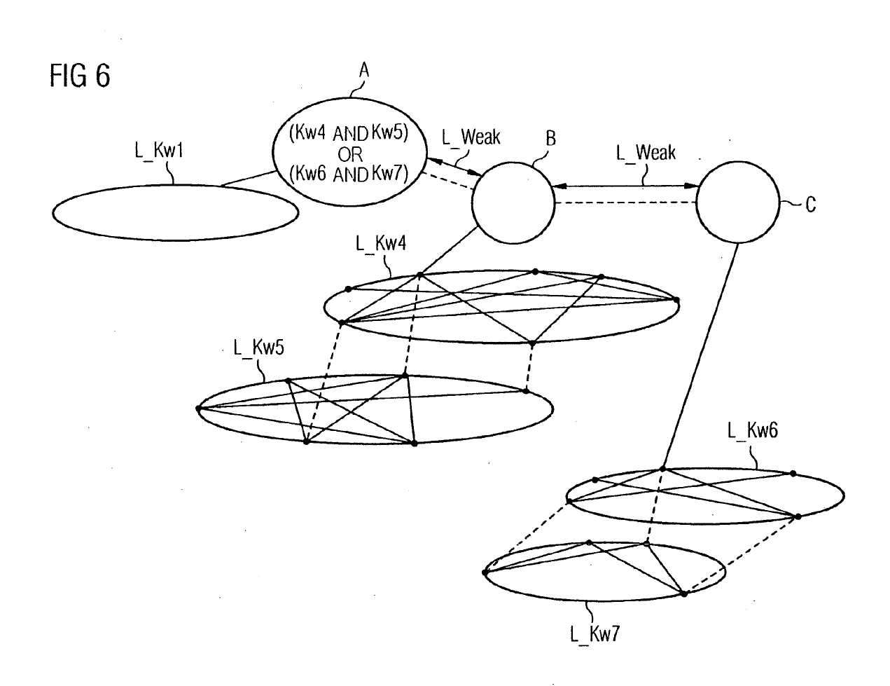

By the method described in the foregoing search queries can be efficiently performed in the data network, as will be explained below with reference to FIGS. 5 and 6.

FIG. 5 shows the layer structure of the data network generated by the above-described initialization method. Illustrated by way of example in FIG. 5 are the three transmission layers L_kw1, L_kw2 and L_kw3 at three different levels. The individual dots in the transmission layers designate the peers which belong to the respective transmission layer and are connected to one another in this layer. As indicated by dashed lines, certain dots are connected to lower or higher transmission layers. The connected dots relate to the same peer and it is made clear hereby that peers may also belong to several transmission layers, i.e. that they have a plurality of keywords in common with other peers.

FIG. 5 depicts a search query according to which an AND search is to be performed for peers which contain the keywords kw1, kw2 and kw3, the search query being addressed from an arbitrary peer X. Peer X sends its search query only to peers which belong to a transmission layer that is characterized by a keyword kw1, kw2 or kw3. In the example described, peer X sends its query to peers of the transmission layer L_kw1. This means that the search query no longer takes into consideration any peers which have none of the transmission layers L_kw1, L_kw2 and L_kw3 in common with peer X, for these peers have none of the keywords kw1, kw2 or kw3. As a result of the search query being forwarded in layer L_kw1, the search query reaches peers which are also located in the further layer L_kw2. Peer Y is shown in FIG. 5 by way of example. Search queries which reach peer Y are subsequently forwarded to peers of the transmission layer L_kw2. As soon as a peer which is also in layer L_kw3 is found in layer L_kw2, the search query has been successful and a peer has been found which contains all three keywords kw1 and kw2 and kw3. A peer found by the search query is designated by Z in FIG. 5. This peer includes files whose contents are of interest to the querying peer X and a transfer of the files can take place subsequently. In this way a very effective search for keywords is ensured, since the search is henceforth only conducted in transmission layers which have at least one keyword in common with the search query.

The case can however occur in which the search query contains keywords which the searching peer does not know at all. In such a case it is not possible to forward the search query to a transmission layer which is characterized by a keyword of the search query. In this case the above-described weak connections via the transmission layer L_weak are used. A corresponding example is shown in FIG. 6, where the search query (“kw4 AND kw5” OR “kw6 AND kw7”) is started by peer A. Peer A is not connected to any of the layers L_kw4, L_kw5, L_kw6 and L_kw7. The search query is therefore also forwarded to peer B, to which a weak connection exists via the layer L_weak. Via peer B the search query reaches the layers L_kw4 and L_kw5, with the result that via said route all peers can be ascertained which contain both keywords kw4 and kw5. However, peer B is not connected to either L_kw6 or L_kw7. For this reason peer B also uses a weak connection via a layer L_weak to peer C. Via peer C it is possible in turn to reach layers L_kw6 and L_kw7 and in this way peers can be ascertained which contain both the keyword kw6 and the keyword kw7. As the preceding explanation illustrates, by the additional use of weak connections it is also possible to reach layers which are not known to the querying peer itself, so the method also enables a search to be made for keywords which the peer that generates the search query itself does not know.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-23. (canceled)

24. A method for initializing and/or updating a data network having a plurality of computers, each computer having stored therein data and one or more keywords which characterize the data, the method comprising:
forwarding a message between at least some of the computers to ascertain which computers have similar keywords stored therein;
generating a transmission layer for each similar keyword, the computers having the similar keyword belonging to the transmission layer; and
storing information on the computers having the similar keyword, the information indicating to which transmission layers the respective computer belongs and, for each transmission layer to which the computer belongs, the information also identifying which other computers belong to the transmission layer.

25. The method as claimed in claim 24, wherein a peer-to-peer network is initialized and/or updated.

26. The method as claimed in claim 24, wherein after the message is processed and forwarded once, the message is not processed and forwarded again by the same computer.

27. The method as claimed in claim 24, wherein forwarding the message comprises:
generating the message at a sending computer, the message identifying the sending computer and at least some of the keywords stored in the sending computer;
forward the message between the computers in the data network, each forwarding computer that receives the message ascertaining any keywords identified in the message which are similar to the keywords stored in the forwarding computer; and
if one or more similar keywords has been ascertained, sending a response to the sending computer, the response identifying the forwarding computer and identifying which keywords are similar.

28. The method as claimed in claim 27, wherein generating a transmission layer and storing information on the computers comprises:
for each keyword that is ascertained to be similar, assigning the sending computer to the transmission layer associated with the keyword, the sending computer being assigned at the forwarding computer; and
for each similar keyword identified in a response, assigning the forwarding computer to the transmission layer associated with the keyword, the forwarding computer being assigned at the sending computer.

29. The method as claimed in claim 24, wherein a separate transmission layer is generated for computers which are connected and which have no transmission layer in common.

30. The method as claimed in claim 24, wherein messages are forwarded and transmission layers are generated at predefined time intervals and/or when the keywords stored in the computers change.

31. The method as claimed in claim 30, wherein the messages are exchanged between computers which belong to the same transmission layer.

32. The method as claimed in claim 24, wherein the computers of the data network communicate with one another via internet connections.

33. The method as claimed in claim 32, wherein IP addresses are used to identify the computers.

34. The method as claimed in claim 24, wherein the computers manage files and each file is assigned a keyword characterizing the contents of the file and being searchable by users of the computers in the data network.

35. The method as claimed in claim 24, wherein at least some of the computers assign priorities to the transmission layers.

36. The method as claimed in claim 35, wherein a transmission layer receives a higher priority if the keyword assigned to the transmission layer is more frequently searched and/or found in the data network.

37. A method for locating data in a data network having a plurality of computers, each computer having data stored therein and one or more keywords linked to the data which characterize the data, the method comprising:
forwarding a message between at least some of the computers to ascertain which computers have similar keywords stored therein;
generating a transmission layer for each similar keyword, the computers having the similar keyword belonging to the transmission layer;
storing information on the computers having the similar keyword, the information indicating to which transmission layers the respective computer belongs and, for each transmission layer to which the computer belongs, the information also identifying which other computers belong to the transmission layer;
generating a search query for a desired keyword, the search query being generated by a searching computer of the data network;
identifying the transmission layer associated with the desired keyword;
forwarding the search query preferably to the computers belonging to the transmission layer associated with the desired keyword;
receiving the search query at a target computer; and
locating data stored on the target computer in response to the search query, the data located at the target computer being data linked to the desired keyword.

38. The method as claimed in claim 37, wherein the data is located in a peer-to-peer network.

39. The method as claimed in claim 37, wherein if a searching computer does not belong the transmission layer associated with the desired keyword, the search query is forwarded to all computers having a transmission layer in common with the searching.

40. The method as claimed in claim 37, wherein when an intermediate computer receives the search query from the searching computer, the intermediate computer identifies at least one new transmission layer, each new transmission layer being a transmission layer associated with the intermediate computer and not associated with the searching computer, the intermediate computer forwarding the search query only to computers associated with the at least one new transmission layer.

41. The method as claimed in claim 37, wherein after a computer processes and forwards the search query for a first time, the same computer does not process and forward the search query for a second time.

42. The method as claimed in claim 37, wherein
the transmission layers are assigned different priorities, and
the search query is forwarded only to computers belonging to a high priority transmission layer.

43. The method as claimed in claim 27, further comprising, after the data is located, transmitting the data to the searching computer.

44. The method as claimed in claim 43, wherein the data is transmitted in a peer-to-peer network.

45. A data network having a plurality of computers embodied to perform the method as claimed in claim 24.

46. The data network as claimed in claim 45, wherein the data network is a peer-to-peer network.
